(19) United States
(12) Patent Application Publication
(10) Pub. No.: US 2002/0033908 A1
(43) Pub. Date: Mar. 21, 2002

(54) Liquid crystal display

(76) Inventors: Yuji Mori, Urizura-machi (JP); Yoshiharu Nagae, Hitachi-shi (JP); Masato Shimura, Mobara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/953,914

(22) Filed: Sep. 18, 2001

(30) Foreign Application Priority Data
Sep. 18, 2000 (JP) 2000-281406

(51) Int. Cl. G02F 1/1335

(52) U.S. Cl. 349/61

(57) ABSTRACT

Improving low power consumption is provided. A multilayer structure of a first electrode and an organic light-emitting layer plus a second electrode is formed on a liquid crystal-side surface of one substrate of respective substrates that are disposed to oppose each other with a layer of liquid crystals interposed therebetween, featuring that the organic light-emitting layer emits light rays in a way responsive to receipt of a current which is caused to flow between the first electrode and the second electrode.

### BACKGROUND OF THE INVENTION

1. Field of the Invention:

The present invention relates to liquid crystal display devices.

2. Description of the Related Art:

A liquid crystal display device is the one that employs as its outer envelope a pair of substrates as disposed to oppose each other with a layer of liquid crystal material interposed between them and comprises a display section that consists essentially of a great number of picture elements or “pixels” in a spreading direction of the liquid crystal material.

In addition, a pair of electrodes are formed at each pixel for control of the liquid crystal's optical transmissivity by an electric field being created between these electrodes.

Due to this, in view of the fact that a liquid crystal display panel per se does not emit light, a back-light is disposed for example behind of its back surface thus causing penetration or transmission of rays of light from this backlight to thereby enable visual recognition of on-screen display images.

However, it has been pointed out that the backlight is the one which employs as its light source a cold cathode ray tube or tubes, resulting in an increase in power consumption.

### SUMMARY OF THE INVENTION

The present invention was made in view of the above technical background, and is aimed to provide a liquid crystal display device less in power consumption.

### BRIEF DESCRIPTION OF THE DRAWINGS

FIG. 1 is an arrangement diagram showing one embodiment of the liquid crystal display device in accordance with the present invention;

FIG. 2 is an explanation diagram showing a mechanism of light emission of an organic light-emitting layer;

FIG. 3 is an explanation diagram showing the path of light in the case of using as a reflection type liquid crystal display device along with polarized light rays thereof;

FIG. 4 is an arrangement diagram showing another embodiment of the liquid crystal display device in accordance with this invention; and

FIG. 5 is an arrangement diagram showing still another embodiment of the liquid crystal display device in accordance with the invention.

### DESCRIPTION OF THE PREFERRED EMBODIMENTS

A brief summary of a representative one of the inventions as disclosed herein will be explained below.

A liquid crystal display device in accordance with the instant invention is one that is arranged for example in such a manner as to comprise, on or over a liquid crystal-side surface of one substrate of respective substrates as disposed to oppose each other with a layer of liquid crystals interposed therebetween, first electrodes extending in the x direction and being parallel-provided in the y direction and an organic light-emitting layer as formed to cover these first electrodes plus second electrodes extending in the y direction and being parallel-provided in the x direction on a surface of this organic light-emitting layer, and also comprise over a liquid crystal-side surface of a remaining substrate pixel electrodes extending in the x direction and being parallel-provided in the y direction, featured in that the second electrodes also function as opposite electrodes for creation of an electric field between them and the pixel electrodes.

With the liquid crystal display device thus arranged, the organic light-emitting layer becomes a light emission body, resulting in its consumed power becoming much less than that of cold cathode ray tubes or the like.

Additionally, one electrode of the electrodes for letting the organic light-emitting layer emit light rays is arranged to function also as one of the electrodes used to drive liquid crystals.

Owing to this arrangement, when compared to the case of the known liquid crystal display devices, it is now permissible that at least the first electrode(s) and organic light-emitting layer are merely formed on or over the liquid crystal-side substrate surface, resulting in achievement of an extremely simplified arrangement.

Respective embodiments of the liquid crystal display device in accordance with the present invention will now be explained by using the accompanying drawings below.

Embodiment 1

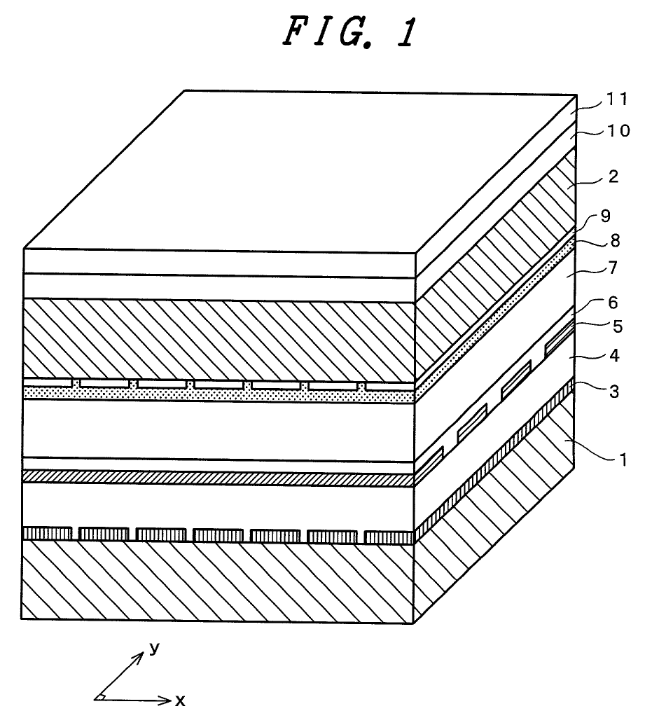

FIG. 1 is a main-part sectional diagram showing one embodiment of the liquid crystal display device in accordance with this invention. Here, this liquid crystal display device is arranged so that it comes with a built-in backlight and thus is employable as the so-called transmission type one which permits penetration of light from the backlight while also being useable as the so-called reflection type one which does not use any light from the backlight and alternatively causes the sunlight to be reflected for visual displaying.

In this drawing, first, there is a substrate 1. This substrate 1 is designed so that it is disposed to oppose a transparent substrate 2, to be later described in the description, with a liquid crystal layer 7 interposed or “sandwiched” therebetween.

This substrate 1 is made of an optically opaque material and may alternatively be comprised of resin materials by way of example. However, glass materials may also be used along with a means for preventing light from the built-in backlight from leaking toward the outside through this substrate 1.

And, this substrate 1 has a liquid crystal-side surface on which first electrodes 3 are formed in such a manner that these extend in the y direction in the drawing and are parallel-provided in the x direction. A width of this first electrode 3 and a distance or “pitch” of neighboring other first electrodes 3 are specifically defined causing a cross-over portion or “intersection” with a second electrode 5 as will be later described to correspond to (overlap) a respective one of individually driven pixel regions of the liquid crystal layer 7.

An organic light-emitting layer 4 is fabricated on the surface of the substrate 1 with the first electrodes 3 formed thereon, in its overall area thereof. This organic light-emitting layer 4 is comprised for example of chosen materials including but not limited to benzothiazole-zinc complex and triphenylamine-based materials or else and is formed by deposition methods by way of example.

Formed on a surface of this organic light-emitting layer 5 are second electrodes 5 which extend in the x direction in the drawing and are parallel-provided in the y direction. A width of this second electrode 5 and a distance of neighboring other second electrodes 5 are defined causing a region of an intersection with the first electrodes 5 to correspond to (overlap) the individually driven respective pixel regions of the liquid crystal layer 7.

With such an arrangement, applying a voltage between the first electrode and second electrode 5 to thereby let a current flow within the organic light-emitting layer 4 would result in the organic light-emitting layer 4 emitting light at the intersection of the first electrode 3 and second electrode 5, thereby causing it to have a function as the backlight of the liquid crystal display device.

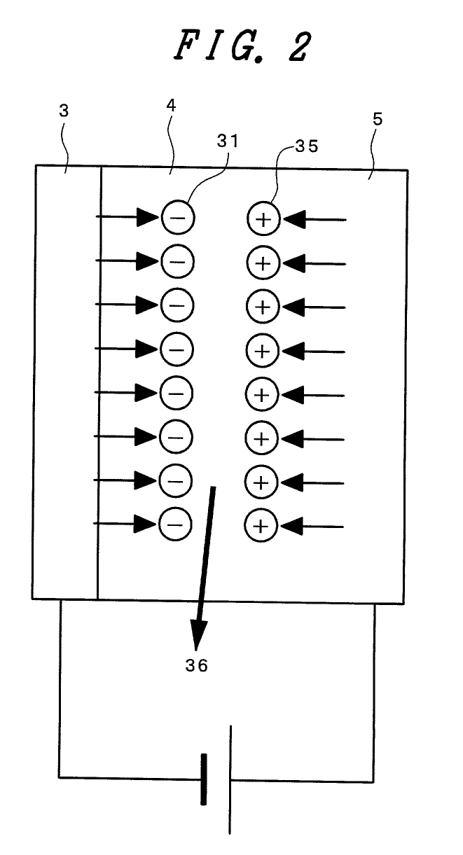

FIG. 2 is a diagram showing a mechanism of light emission upon application of a voltage of the organic light-emitting layer 4; for example, electrons 31 are supplied from the cathode side consisting of the first electrode 3 to the organic light-emitting layer 4 side while letting holes 35 be supplied from the anode side consisting of the second electrode 5 to the organic light-emitting layer 4 side, which leads to recombination of the electrons 31 and holes 35 thus resulting in emission of light rays.

This second electrode 5 is formed of a transparent conductive material such as for example indium-tin-oxide (ITO) in order to cause light being produced within the organic light-emitting layer 4 to irradiate to the liquid crystal side without any obstruction while allowing it to do double-function as an opposite or “counter” electrode of a pair of electrodes for driving the liquid crystal.

As previously stated, since the region of the intersection between the first electrode 3 and second electrode 5 corresponds to (overlap) each pixel region during liquid crystal display driving, each ray of the light coming from the organic light-emitting layer 4 is expected to directly fall onto each pixel corresponding thereto.

And an orientation film 6 is formed in an overall region of the surface of the substrate 1 with the second electrodes 5 formed thereon. This orientation film 6 is a film that is in direct contact with the liquid crystal as will be described later, which film is for determination of the liquid crystal's initial orientation or “alignment” direction.

On the other hand, there is a transparent substrate 2 which is disposed to oppose the substrate 1 with the liquid crystal interposed between them, wherein pixel electrodes 9 are formed on its liquid crystal-side surface so that they extend in the y direction in the drawing and are parallel-provided in the x direction.

This pixel electrode 9 is such that its width and a distance with respect to other neighboring pixel electrodes 9 are substantially the same as those of the first electrode 3; additionally, it is formed to overlap the first electrode 3 when planarly viewing.

And, an orientation film 8 is formed in an entire region of the surface of the transparent substrate 2 with such pixel electrodes 9 formed thereon. This orientation film 8 is a film that is in direct contact with the liquid crystal to be later described, which film determines the liquid crystal's initial alignment direction.

In addition, a wavelength plate 10 is disposed in the entire area of a surface of the transparent substrate 2 on the opposite side to the liquid crystal layer, which plate has its upper surface on which a planarization plate 11 is disposed. These wavelength plate 10 and polarizer plate 11 are provided for enabling visualization of the behavior of liquid crystals.

The liquid crystal display device thus formed in this way is designed to be observable from the polarizer plate 11 side, wherein specific part including the polarizer plate 11, wavelength plate 10, pixel electrodes 9, orientation film 8, liquid crystal layer 7, orientation film 6 and up to the second electrodes 5 (also functioning as counter electrodes) has the function as the liquid crystal display panel whereas part including the second electrodes 5, organic light-emitting layer 4 and up to the first electrodes 3 has the function as the backlight.

Here, the second electrodes 5 are arranged to serve as backlight-side electrodes and also as liquid crystal display device-side electrodes as has been described previously.

Due to this, one embodiment of the drive method may be arranged to include the steps of applying a voltage (e.g. 3 to 7V with respect to the voltage being applied to the second electrodes 5) to all the first electrodes 3, sequentially supplying a scan signal voltage to the second electrodes 5 along the parallel provision direction thereof, and substantially simultaneously supplying an image signal voltage to a respective one of the pixel electrodes 9 in a way synchronous with such timing.

Additionally, letting the first electrodes 3 be formed of a metal layer high in optical reflectivitiy makes it possible even when the organic light-emitting layer 4 is not driven to emit light to permit usage as a reflective liquid crystal display device through reflection of rays of the sunlight at the first electrode(s) 3.

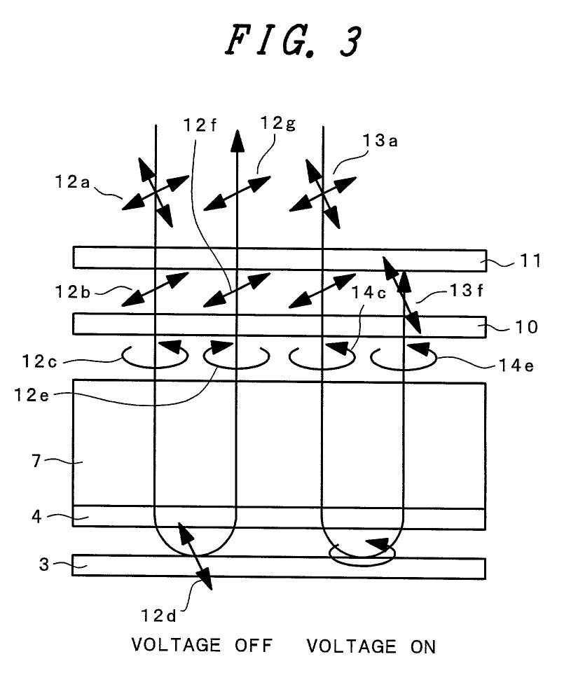

FIG. 3 is an explanation diagram showing travel paths of light rays in the case of usage as such reflective liquid crystal display device, while also including therein several polarized light rays thereof.

First explaining about the case where a voltage being applied to the liquid crystal layer is OFF, as the polarized light, externally incoming light 12a falls onto the polarizer plate (linear polarizer plate) 11, which light is regarded as combined light of two-directional linear polarized light components that randomly cross each other at right angles.

Traveling through the polarizer plate 11 results in one linear polarized light component of the external light 12a being absorbed and thus becoming linear polarized light 12b.

Next, penetrating the wavelength plate (¼ λ wavelength plate) 10 results in the linear polarized light 12b becoming circular polarized light 12c.

While this circular polarized light 12c reaches the first electrode 3 after having passed through the liquid crystal layer 7 and organic light-emitting layer 4, it becomes linear polarized light 12d due to action of the liquid crystal layer 7 in such event. A polarization direction of the linear polarized light 12d in this case is arranged to be at right angles to the polarization direction of the linear polarized light 12b.

While the linear polarized light 12d is reflected by the first electrode 3 to thereby again pass through the organic light-emitting layer 4 and liquid crystal layer 7, it becomes circular polarized light 12e due to the action of the liquid crystal layer 7 in such event. The rotation direction of polarization of this circular polarized light 12e is reverse to the rotation direction of polarization of the circular polarized light 12c.

The circular polarized light 12e becomes linear polarized light 12f after having penetrated the wavelength plate 10; then, this linear polarized light 12f directly passes through a linear polarizer plate and finally reaches an observer's eyes as display light 12g.

Next explaining about the case where the voltage being added to the liquid crystal layer is ON, first the liquid crystal layer 7's molecules behave to align with the direction of an electric field (up/down direction on the drawing sheet) so that the liquid crystal layer 7 will no longer give any optical actions to the light that passes through it.

Due to this, up to a time point prior to penetration of the liquid crystal layer 7 from the external light 13a, the voltage being applied to the liquid crystal layer is the same as that in the case of OFF; thus, it becomes circular polarized light 14c. This circular polarized light 14c is continuously set in the state of circular polarized light 14e prior to penetration of the liquid crystal layer 7 and organic light-emitting layer 4 and after having passed through the organic light-emitting layer 4 and liquid crystal layer 7.

And, after having passed through the wavelength plate 10, it becomes linear polarized light 13f: in view of the fact that the polarization direction of this linear polarized light 13f is perpendicular to the polarization direction of the polarizer plate 11, it is absorbed by the polarizer plate 11 and thus becomes dark display light.

The liquid crystal display device thus arranged in this way is such that the organic light-emitting layer 4 becomes its light emitting body and its power consumption becomes extremely less when compared for example to cold cathode ray tubes or the like.

In addition, one electrode of the electrodes for causing the organic light-emitting layer 4 to emit light is arranged to do double-duty as one of the electrodes for driving the liquid crystal.

Owing to this, when compared to liquid crystal display devices of the related art, it is permitted that at least the first electrodes 3 and organic light-emitting layer 4 may be merely formed on the substrate surface on the liquid crystal side, resulting in successful achievement of much simplified arrangement.

Embodiment 2

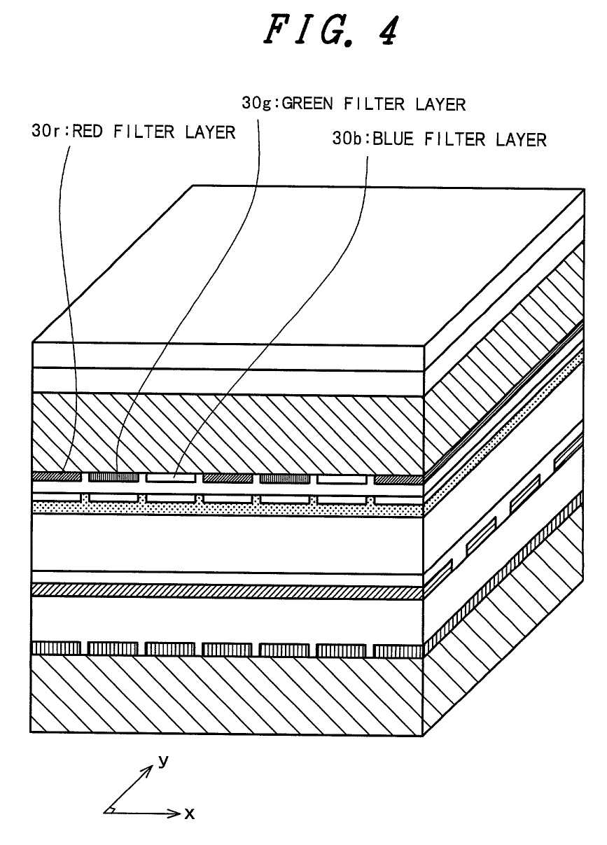

FIG. 4 is a cross-sectional diagram showing another embodiment of the liquid crystal display device in accordance with this invention, which is the diagram that corresponds to FIG. 1.

FIG. 4 depicts a color liquid crystal display device, an arrangement of which is different from that of FIG. 1 in that color filters 30 are formed on the liquid crystal-side surface of the transparent substrate 2 with a planarization film 31 being formed to cover these color filters 30 and also with pixel electrodes 9 similar to those of FIG. 1 being formed on a surface of this planarization film 31.

The color filters 30 are so formed as to extend in the y direction in the drawing and are parallel-provided in the x direction and also formed to overlie or overlap the pixel electrodes 9.

The color filters 30 are such that red filter layers 30r, green filter layers 30g and blue filter layers 30b are recurrently formed in the x direction in this order of sequence.

Embodiment 3

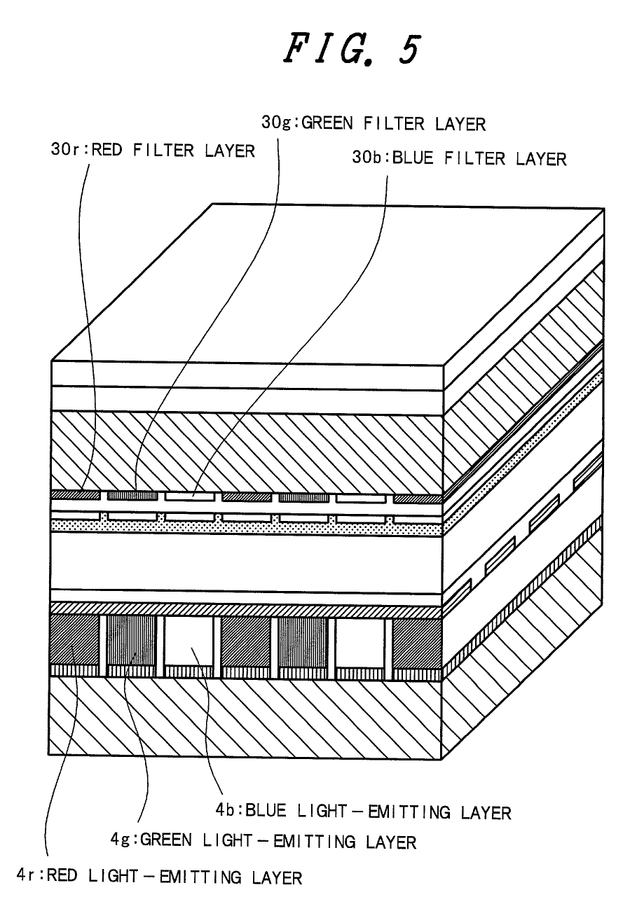

FIG. 5 is a sectional diagram showing still another embodiment of the liquid crystal display device in accordance with the invention, which is the diagram that corresponds to FIG. 4.

In this embodiment, red light-emitting layers 4r and green light-emitting layers 4g plus blue light-emitting layers 4b are selectively formed at the organic light-emitting layer 4, wherein they are sequentially formed repeatedly in the X direction.

Here, the green light-emitting layers 4g are made for example of certain material called tris (8-quinolinolate) aluminum; the blue light-emitting layers 4b are made of the material called 4,4′-bis(2,2-diphenylvinyl)biphenyl; and, the red light-emitting layers 4r are comprised of the material of the green light-emitting layers 4g with 4-(dicyanomethylene)-2-methyl-6-(p-dimethylaminostyryl)-4H-pyran doped thereinto.

It is needless to say that although in the drawing the color filters 30 are also formed on the transparent substrate 2 side, an arrangement may also be employable with no such color filters 30.

As apparent from the foregoing explanation, in accordance with the liquid crystal display device embodying the invention, it is possible to obtain the one of low power consumption.

What is claimed is:

1. A liquid crystal display device comprising, on or over a liquid crystal-side surface of one substrate of respective substrates as disposed to oppose each other with a layer of liquid crystals interposed therebetween, a multilayer structure of a first electrode and an organic light-emitting layer plus a second electrode,
said organic light-emitting layer emitting light in response to a current flowing between the first electrode and the second electrode.

2. A liquid crystal display device comprising, on or over a liquid crystal-side surface of one substrate of respective substrates as disposed to oppose each other with a layer of liquid crystals interposed therebetween, first electrodes extending in the x direction and being parallel-provided in the y direction and an organic light-emitting layer as formed to cover these first electrodes plus second electrodes extending in the y direction and being parallel-provided in the x direction on a surface of this organic light-emitting layer,
regions for cross-over intersection between said first electrodes and said second electrodes being arranged to overlap respective pixel regions for individually driving said liquid crystals.

3. A liquid crystal display device comprising, on or over a liquid crystal-side surface of one substrate of respective substrates as disposed to oppose each other with a layer of liquid crystals interposed therebetween, first electrodes extending in the x direction and being parallel-provided in the y direction and an organic light-emitting layer as formed to cover these first electrodes plus second electrodes extending in the y direction and being parallel-provided in the x direction on a surface of this organic light-emitting layer; and also comprising over a liquid crystal-side surface of a remaining substrate pixel electrodes extending in the x direction and being parallel-provided in the y direction,
said second electrodes also functioning as opposite electrodes for creation of an electric field between them and said pixel electrodes.

4. A liquid crystal display device comprising, on or over a liquid crystal-side surface of one substrate of respective substrates as disposed to oppose each other with a layer of liquid crystals interposed therebetween, first electrodes extending in the x direction and being parallel-provided in the y direction and an organic light-emitting layer as formed to cover these first electrodes plus second electrodes extending in the y direction and being parallel-provided in the x direction on a surface of this organic light-emitting layer; and also comprising over a liquid crystal-side surface of a remaining substrate pixel electrodes extending in the x direction and being parallel-provided in the y direction,
said second electrodes also functioning as opposite electrodes for creation of an electric field between them and said pixel electrodes, and
said first electrodes being formed of a conductive material permitting reflection of light rays.

5. The liquid crystal display device as recited in any one of the preceding claims 3 and 4, wherein the pixel electrodes and the opposite electrode are formed of conductive material permitting transmission of light rays.

6. A liquid crystal display device comprising, on or over a liquid crystal-side surface of one substrate of respective substrates as disposed to oppose each other with a layer of liquid crystals interposed therebetween, a sequential multilayer structure of a first electrode and an organic light-emitting layer plus a second electrode; and also comprising more than one pixel electrode on a liquid crystal-side surface of the remaining substrate,
said second electrode also functioning as an opposite electrode for creation of an electric field between it and said pixel electrode.

7. A liquid crystal display device comprising, on or over a liquid crystal-side surface of one substrate of respective substrates as disposed to oppose each other with a layer of liquid crystals interposed therebetween, a sequential multilayer structure of a first electrode and an organic light-emitting layer plus a second electrode,
at least one electrode of the first electrode and the second electrode being comprised of a plurality of stripe-shaped electrodes extending in one direction and being parallel-provided in a direction at right angles to said one direction,
an organic light-emitting layer in a region with these respective stripe-shaped electrodes formed therein being formed of a material permitting development of a color as selected from the group consisting of red, green and blue, and
the material of said organic light-emitting layer being chosen while letting the three colors be sequentially repeated in the parallel-provision direction of said stripe-shaped electrodes.

8. The liquid crystal display device as recited in claim 7, wherein said first electrode is comprised of a metal permitting reflection of light rays.
